(19) United States
(12) Patent Application Publication
(10) Pub. No.: US 2026/0251851 A1
(43) Pub. Date: Aug. 27, 2026

(54) OPTICAL WAVELENGTH VARIABLE FILTER, METHOD OF CONTROLLING THE SAME, AND OPTICAL TRANSCEIVER

(71) Applicant: NEC Corporation, Tokyo (JP)

(72) Inventor: Ryo MARUYAMA, Tokyo (JP)

(73) Assignee: NEC Corporation, Tokyo (JP)

(21) Appl. No.: 19/539,360

(22) Filed: Feb. 13, 2026

(30) Foreign Application Priority Data
Feb. 26, 2025 (JP) 2025-028932

(51) Int. Cl. G02B 6/293; G02B 6/12; H04J 14/02

(52) U.S. Cl. CPC G02B 6/29395; G02B 6/12007; H04J 14/0227

(57) ABSTRACT

A plurality of optical wavelength filters are cascade-connected. Each of a plurality of photodetectors detects light transmitted through the plurality of optical wavelength filters, and outputs a current signal indicating intensity of the detected light via two output terminals. An electrode pair includes a first electrode pad connected to one of the two output terminals of each of the plurality of photodetectors and a second electrode pad connected to the other of the two output terminals.

### INCORPORATION BY REFERENCE

This application is based upon and claims the benefit of priority from Japanese patent application No. 2025-28932, filed on February 26, 2025, the disclosure of which is incorporated herein in its entirety by reference.

### TECHNICAL FIELD

The present disclosure relates to an optical wavelength variable filter, a method of controlling the same, and an optical transceiver.

### BACKGROUND ART

In a transmission system of an optical signal subjected to wavelength division multiplexing, an optical wavelength filter is used to control a wavelength of an optical signal. The optical wavelength filter can transmit only light in a set transmission band and block optical noise other than the transmission band. An optical wavelength variable filter capable of changing the transmission band is widely used in a flexible transmission network (e.g., JP 2017-15788 A).

A waveguide-type ring resonator and a Mach-Zehnder Interferometer (MZI) can function as an optical wavelength filter by utilizing the feature that the transmission band can be changed. In the ring resonator and the MZI, the transmission band changes by controlling the temperature of the waveguide by a micro-heater provided in the vicinity of the waveguide.

Haoyan Wang, et al., “Polarization-independent tunable optical filter with variable bandwidth based on silicon-on-insulator waveguides,” Nanophotonics, Vol.7, Issue 8, pp. 1469-1477, 2018 has proposed an optical wavelength filter capable of achieving a transmission band and a wide cutoff band by a Vernier effect in which two ring resonators having different circumference lengths are connected. In the optical wavelength filter, the waveguide is heated by a micro-heater disposed in the vicinity of the waveguide of the ring resonator to change resonance characteristics of the ring resonator, thereby changing the transmission band.

### SUMMARY

However, in Haoyan Wang, et al., “Polarization-independent tunable optical filter with variable bandwidth based on silicon-on-insulator waveguides,” Nanophotonics, Vol.7, Issue 8, pp. 1469-1477, 2018, a structure and a control method for adjusting transmission bands of each of two ring resonators to a desired band are not clear. Therefore, there is a demand for an optical wavelength variable filter capable of suitably adjusting transmission bands of a plurality of cascade-connected ring resonators with a simple configuration and a control method.

An optical wavelength variable filter according to one example aspect of the present disclosure includes a plurality of cascade-connected optical wavelength filters, a plurality of photodetectors that each detects light transmitted through the plurality of optical wavelength filters and outputs a current signal indicating intensity of the detected light via two output terminals, and an electrode pair including a first electrode pad connected to one of the two output terminals of each of the plurality of photodetectors and a second electrode pad connected to the other of the two output terminals.

A control method of an optical wavelength variable filter according to one example aspect of the present disclosure includes a plurality of cascade-connected optical wavelength filters, a plurality of photodetectors that each detects light transmitted through the plurality of optical wavelength filters and outputs a current signal indicating intensity of the detected light via two output terminals, and an electrode pair including a first electrode pad connected to one of the two output terminals of each of the plurality of photodetectors and a second electrode pad connected to the other of the two output terminals, the method including inputting light to the optical wavelength filter of a foremost stage among the plurality of optical wavelength filters, monitoring, through the electrode pair, a detection signal obtained by adding a plurality of the current signals output from the plurality of optical wavelength filters, and setting transmission bands of the plurality of optical wavelength filters such that intensity of the light that passed through each of the plurality of optical wavelength filters becomes a maximum in order from the optical wavelength filter at the foremost stage to the optical wavelength filter at the last stage.

According to the present disclosure, an optical wavelength variable filter capable of efficiently setting a transmission band with a simple configuration, a method of controlling the same, and an optical transceiver can be provided

### BRIEF DESCRIPTION OF THE DRAWINGS

FIG. 1 is a diagram schematically illustrating a configuration example of an optical transceiver on which a general optical wavelength variable filter is mounted;

FIG. 2 is a diagram schematically illustrating a configuration of an optical transmitter;

FIG. 3 is a diagram schematically illustrating a configuration example of a general optical wavelength variable filter;

FIG. 4 is a diagram schematically illustrating a configuration example of an optical transceiver on which an optical wavelength variable filter according to one example embodiment is mounted;

FIG. 5 is a diagram schematically illustrating a configuration of an optical transmitter according to one example embodiment;

FIG. 6 is a diagram schematically illustrating a configuration of an optical wavelength variable filter according to one example embodiment; and

FIG. 7 is a flowchart of a transmission band control operation of the ring resonator included in the optical wavelength variable filter according to one example embodiment.

### EXAMPLE EMBODIMENT

Hereinafter, example embodiments of the present invention will be described with reference to the drawings. In the drawings, the same elements are denoted by the same reference signs, and redundant description will be omitted as necessary.

Hereinafter, the term “one example embodiment” means that it is applicable to any of the example embodiments described below or a combination of two or more example embodiments, and the application is not limited to a specific example embodiment.

As a premise for understanding the configuration and operation of the optical wavelength variable filter according to the example embodiment described below, first, the configuration and operation of a general optical wavelength variable filter provided in an optical transceiver will be described.

As an example of an optical wavelength variable filter for precisely filtering a wavelength of light, a configuration in which a plurality of single filters including a ring resonator and a Mach-Zehnder interferometer (MZI) are cascade-connected is known. Hereinafter, for the sake of convenience of description, a configuration example in which a ring resonator is applied to a single filter to be cascade-connected will be described. It goes without saying that MZI may be applied instead of the ring resonator. In the optical wavelength variable filter in which a plurality of ring resonators are cascade-connected, a periodic transmission wavelength region appears. Therefore, a desired transmission wavelength band and a wide cutoff wavelength band can be achieved by cascade-connecting a plurality of single filters of different designs as in Haoyan Wang, et al., “Polarization-independent tunable optical filter with variable bandwidth based on silicon-on-insulator waveguides,” Nanophotonics, Vol.7, Issue 8, pp. 1469-1477, 2018. Such a technique is called a Vernier effect, and is used in various types of optical wavelength variable filters.

A micro-heater is disposed in the vicinity of the waveguide forming the ring resonator. By heating the waveguide by the micro-heater, the refractive index of the waveguide, that is, the optical path length can be changed by the thermo-optic effect. As a result, the transmission band of each of the ring resonators can be changed. Therefore, the optical wavelength variable filter can be achieved by adjusting the transmission bands of all the single filters provided in the optical wavelength variable filter to a desired transmission band.

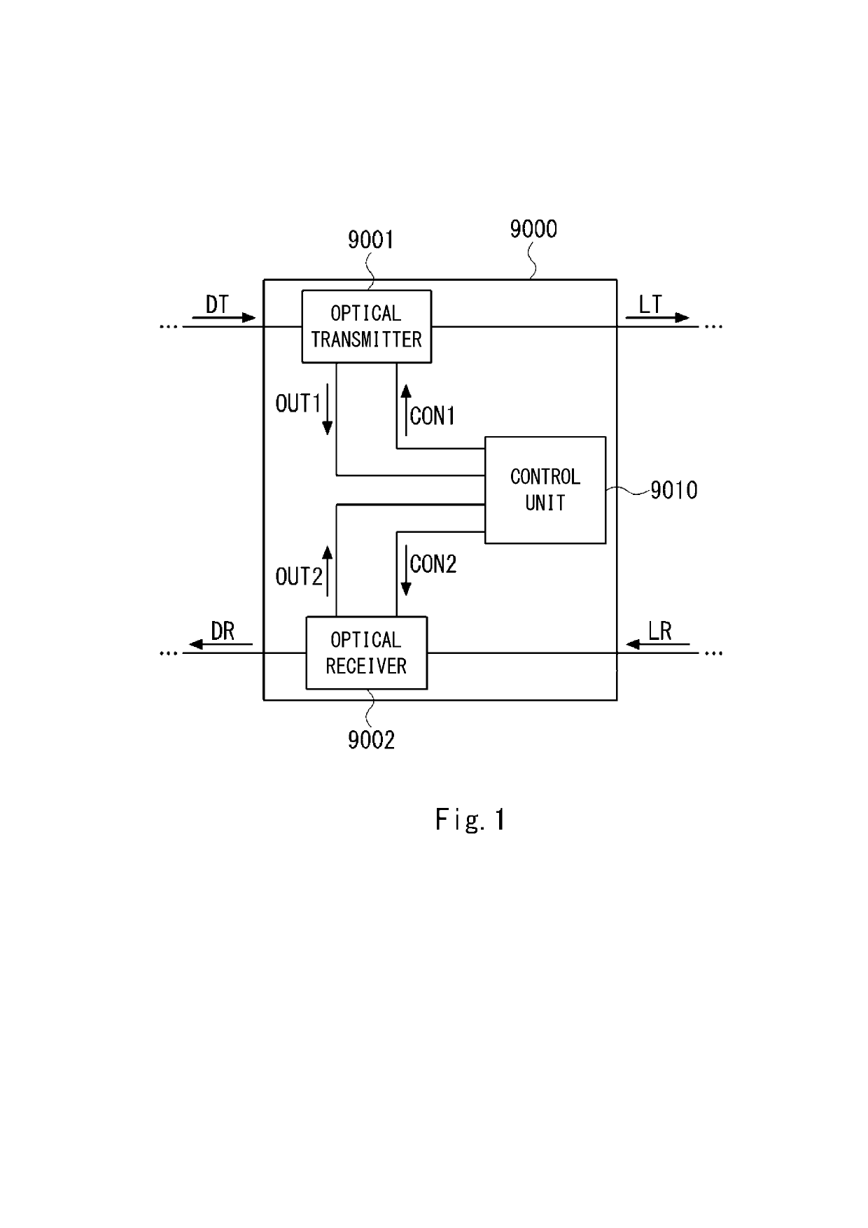

Hereinafter, a configuration of a general optical wavelength variable filter and adjustment of a transmission band will be described using a specific example. FIG. 1 is a diagram schematically illustrating a configuration example of an optical transceiver on which a general optical wavelength variable filter is mounted. An optical transceiver 9000 is installed in, for example, a terminal station device. The optical transceiver 9000 includes an optical transmitter 9001, an optical receiver 9002, and a control unit 9010.

The optical transmitter 9001 transmits, for example, an optical signal LT modulated according to a transmission data signal DT provided from the terminal station device to the optical transmitter 9001 to a communication partner of the optical transceiver 9000. Furthermore, the optical transmitter 9001 may output an output signal OUT1 indicating the operation state of the optical transmitter 9001 to the control unit 9010. The optical receiver 9002 demodulates an optical signal LR input from a communication partner of the optical transceiver 9000 into a received data signal DR. The optical receiver 9002 outputs the received data signal DR to, for example, the terminal station device. Furthermore, the optical receiver 9002 may output an output signal OUT2 indicating the operation state of the optical receiver 9002 to the control unit 9010.

The control unit 9010 controls transmission of the optical signal LT in the optical transmitter 9001 by providing a control signal CON1 to the optical transmitter 9001. Furthermore, the control unit 9010 can grasp the operation state of the optical transmitter 9001 based on the output signal OUT1 received from the optical transmitter 9001. In this case, the control unit 9010 may control the transmission of the optical signal LT in the optical transmitter 9001 by providing the control signal CON1 according to the grasped operation state of the optical transmitter 9001.

The control unit 9010 controls reception of the optical signal LR in the optical receiver 9002 by providing the control signal CON2. Furthermore, the control unit 9010 can grasp the operation state of the optical receiver 9002 based on the output signal OUT2 received from the optical receiver 9002. In this case, the control unit 9010 may control the reception of the optical signal LR in the optical receiver 9002 by providing the control signal CON2 according to the grasped operation state of the optical receiver 9002.

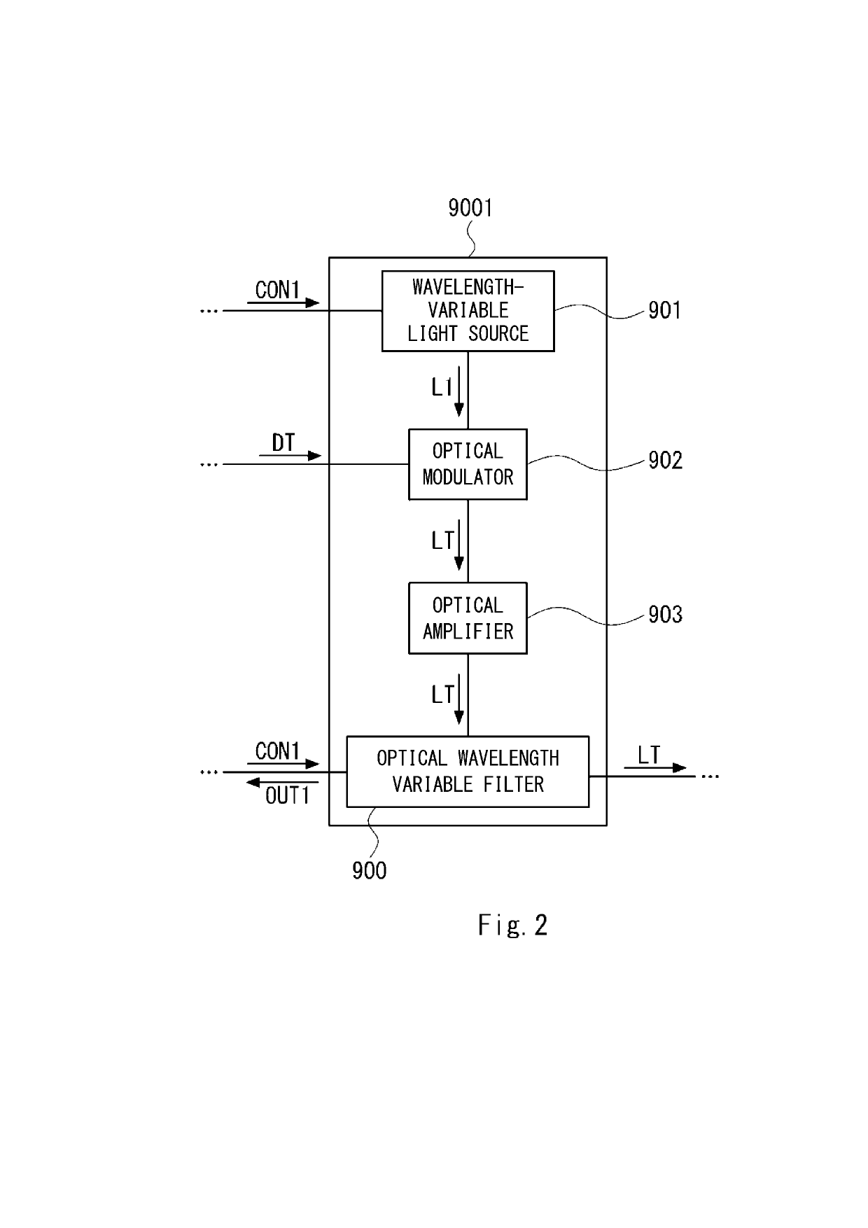

FIG. 2 is a diagram schematically illustrating a configuration of an optical transmitter. The optical transmitter 9001 includes a wavelength-variable light source 901, an optical modulator 902, an optical amplifier 903, and an optical wavelength variable filter 900. The optical wavelength variable filter 900 is an example of a general optical wavelength variable filter.

The wavelength-variable light source 901 outputs light L1 having a desired wavelength to the optical modulator 902. The wavelength-variable light source 901 may be configured as various types of light emitting elements and light source devices. For example, the wavelength-variable light source 901 may be configured to input light output from a light source element such as an optical amplifier to an optical wavelength filter and output light L1 having a desired wavelength that has passed through the optical wavelength filter. The optical wavelength filter included in the wavelength-variable light source 901 may be provided in, for example, a silicon photonics (SiP) element formed on a silicon substrate.

The optical modulator 902 outputs, to the optical amplifier 903, an optical signal LT obtained by modulating the light L1 output from the wavelength-variable light source 901 by a predetermined modulation scheme according to the transmission data signal DT.

The optical amplifier 903 amplifies the optical signal LT to a desired intensity. The optical amplifier 903 outputs the amplified optical signal LT to the optical wavelength variable filter 900.

The optical wavelength variable filter 900 that is an example of a general optical wavelength variable filter, performs wavelength filtering on the optical signal LT. Then, the optical wavelength variable filter 900 outputs the optical signal LT after the wavelength filtering. Thereafter, the optical signal LT is transmitted to a communication partner of the optical transceiver 9000 through an optical transmission line (not illustrated) such as an optical fiber cable.

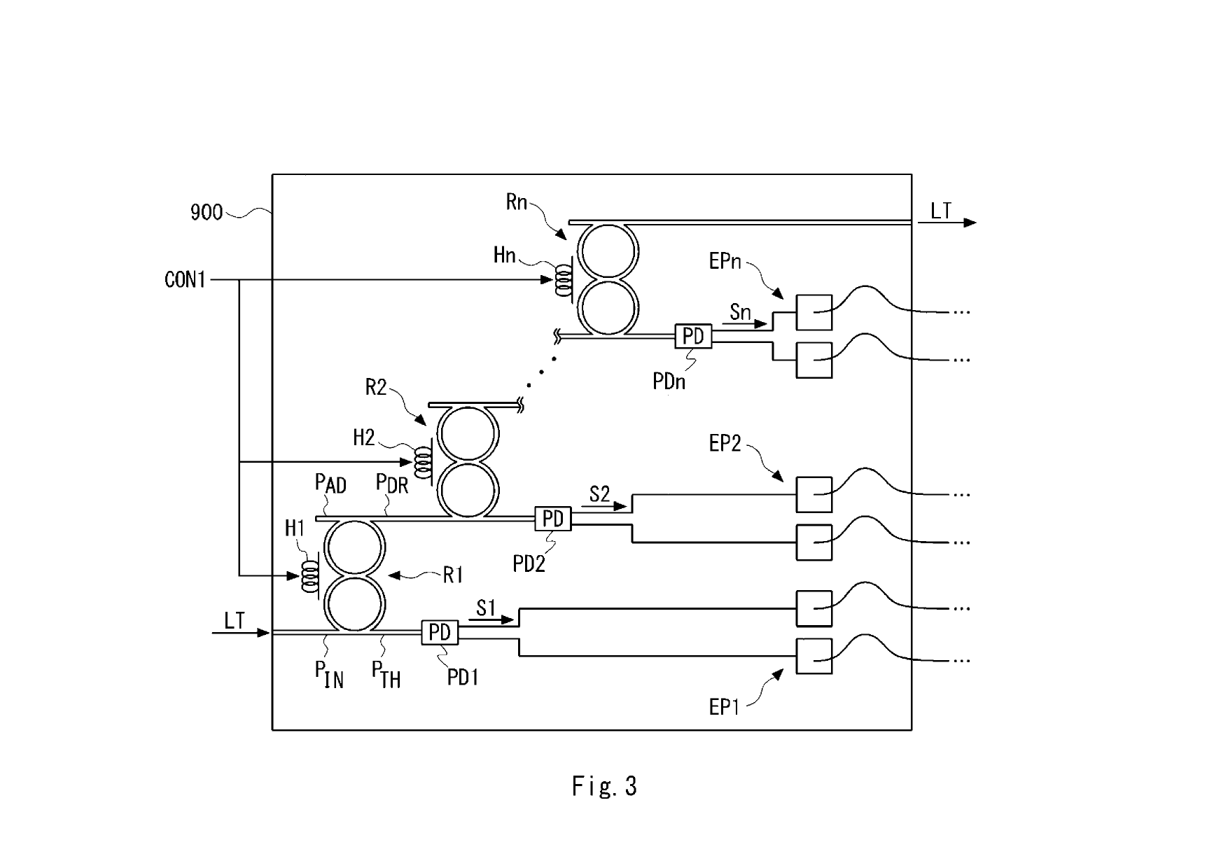

The optical wavelength variable filter 900 will be described. FIG. 3 is a diagram schematically illustrating a configuration example of a general optical wavelength variable filter. The optical wavelength variable filter 900 includes a plurality of ring resonators, a plurality of photodetectors, and a plurality of electrode pairs. Hereinafter, n is an integer equal to or greater than two. FIG. 3 illustrates an example in which the optical wavelength variable filter 900 includes ring resonators R1 to Rn, photodetectors PD1 to PDn, and electrode pairs EP1 to EPn.

In FIG. 3, an input port P_{IN}, a through port P_{TH}, an add port P_{AD}, and a drop port P_{DR} are displayed as representatives in the ring resonator R1 in order to indicate the ports of the ring resonator. The arrangement of the ports is similar in the ring resonators R2 to Rn.

The ring resonators R1 to Rn are cascade-connected between an input terminal of the optical signal LT and an output terminal of the optical signal LT. That is, focusing on the two adjacent ring resonators in the ring resonators R1 to Rn, the drop port that is the output terminal of the ring resonator at the front stage is connected to the input port that is the input terminal of the ring resonator at the back stage. The optical signal LT is input to an input port that is an input terminal of the ring resonator R1 at the foremost stage. The optical signal LT after wavelength filtering is output from the drop port that is the output terminal of the ring resonator Rn at the last stage.

In order to monitor the optical signal LT that has not passed through each of the ring resonators R1 to Rn, each of the photodetectors PD1 to PDn is connected to the through port of each of the ring resonators R1 to Rn. As a result, the optical signal LT that has not passed through each of the ring resonators R1 to Rn is input to the photodetectors PD1 to PDn. For example, a photodiode may be used as the photodetectors PD1 to PDn.

The photodetectors PD1 to PDn output detection signals S1 to Sn indicating the light intensity of the input light. In this example, the photodetectors PD1 to PDn are configured as photodiodes that output current signals associated with the intensity of received light as the detection signals S1 to Sn. Therefore, the anode of each of the photodetectors PD1 to PDn is connected to one of the two electrode pads included in the electrode pairs EP1 to EPn, and the cathode is connected to the other of the two electrode pads.

As a result, for example, the control unit 9010 can receive the detection signals S1 to Sn via the electrode pairs EP1 to EPn. Here, the detection signals S1 to Sn correspond to the above-described output signal OUT1. The control unit 9010 can set the transmission bands of the ring resonators R1 to Rn to desired bands by controlling the micro-heaters H1 to Hn provided in the ring resonators R1 to Rn by the control signal CON1 to minimize the detection signals S1 to Sn.

In the drawing, an example in which the control signal CON1 is provided to the micro-heaters H1 to Hn is illustrated, but this is merely an example. That is, this does not mean that the same signal is provided to the micro-heaters H1 to Hn, and different signals for driving the micro-heaters H1 to Hn may be provided to the micro-heaters H1 to Hn. Furthermore, a signal for driving the micro-heaters H1 to Hn may be provided to each of the micro-heaters H1 to Hn from a driving means controlled by a control means such as the control unit 9010.

In the general optical wavelength variable filter 900, the electrode pairs EP1 to EPn are provided in correspondence with each of the ring resonators R1 to Rn. Since the two electrodes included in each of the electrode pairs EP1 to EPn are connected to an external device by wire bonding or the like, the electrodes are formed as electrodes having a certain area. Therefore, in the optical wavelength variable filter 900 in which n sets of electrode pairs are provided, the overall dimension becomes large, and the footprint reduction is restricted.

On the other hand, an optical transceiver and an optical transmitter are required to be further downsized. Therefore, it is required to achieve downsizing of a wavelength variable filter used in an optical transceiver.

In addition, in the general optical wavelength variable filter 900, the intensity of light that has not transmitted through each of the ring resonators R1 to Rn is detected by the photodetectors PD1 to PDn connected to the through ports. On the other hand, in a state where the adjustment of the transmission bands of the ring resonators R1 to Rn is not completed, it is assumed that the intensity of the light input to the ring resonator on the downstream side is originally small. In this case, the intensity of light detected by the photodetector connected to the through port of the ring resonator on the downstream side also becomes smaller. As a result, a situation in which the monitoring of light by the photodetector does not function sufficiently may occur.

An optical wavelength variable filter that solves the problem in the general optical wavelength variable filter described above will be described below.

### First Example Embodiment

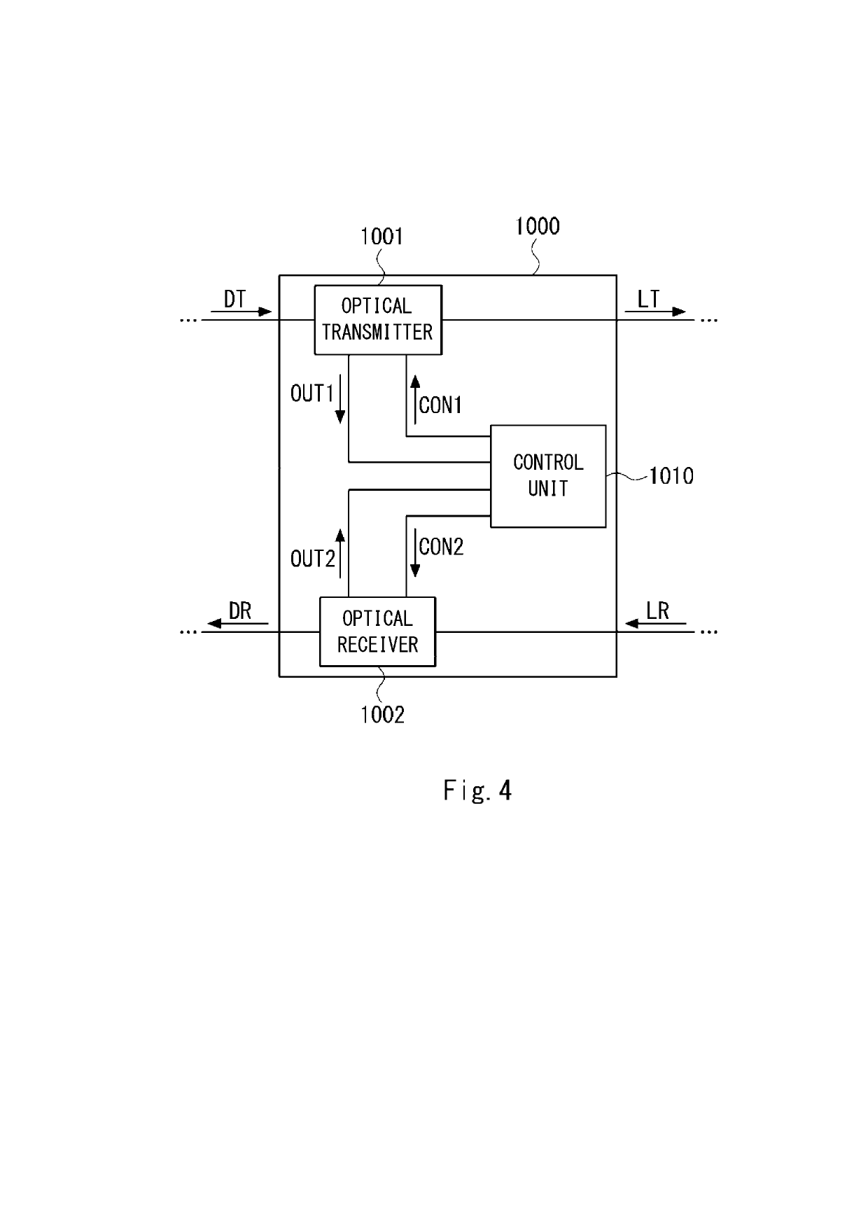

A wavelength variable filter according to a first example embodiment will be described. FIG. 4 is a diagram schematically illustrating a configuration example of an optical transceiver on which an optical wavelength variable filter according to one example embodiment is mounted. An optical transceiver 1000 is installed in, for example, a terminal station device. The optical transceiver 1000 has a configuration similar to that of the optical transceiver 9000 illustrated in FIG. 1. That is, an optical transmitter 1001, an optical receiver 1002, and a control unit 1010 of the optical transceiver 1000 correspond to the optical transmitter 9001, the optical receiver 9002, and the control unit 9010 of the optical transceiver 9000.

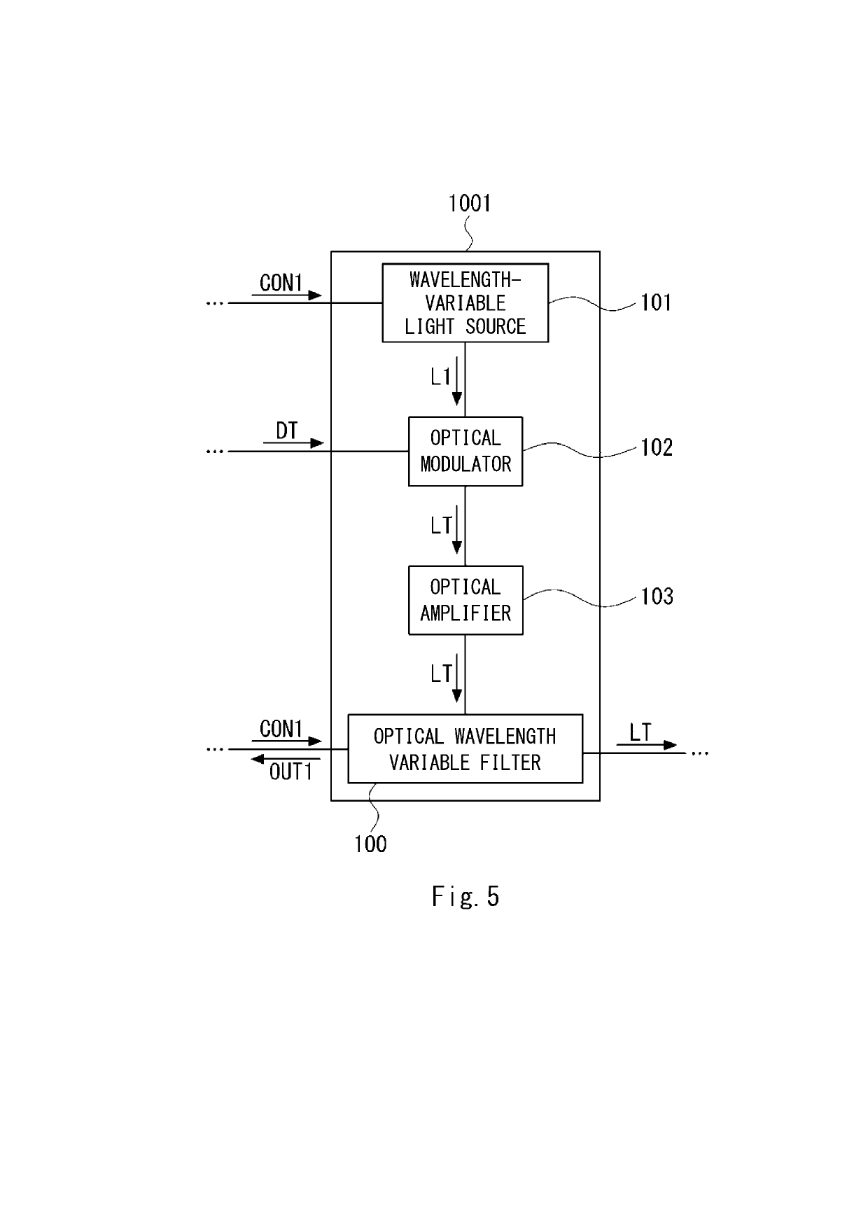

FIG. 5 is a diagram schematically illustrating a configuration of an optical transmitter according to one example embodiment. The optical transmitter 1001 has a configuration similar to that of the optical transmitter 9001 in FIG. 2. That is, a wavelength-variable light source 101, an optical modulator 102, an optical amplifier 103, and an optical wavelength variable filter 100 of the optical transmitter 1001 correspond to the wavelength-variable light source 901, the optical modulator 902, the optical amplifier 903, and the optical wavelength variable filter 900 of the optical transmitter 9001.

The optical wavelength variable filter 100 according to the present example embodiment will be described. The optical wavelength variable filter 100 performs wavelength filtering on the optical signal LT. Then, the optical wavelength variable filter 100 outputs the optical signal LT after the wavelength filtering. Thereafter, the optical signal LT is transmitted to a communication partner of the optical transceiver 1000 through an optical transmission line (not illustrated) such as an optical fiber cable.

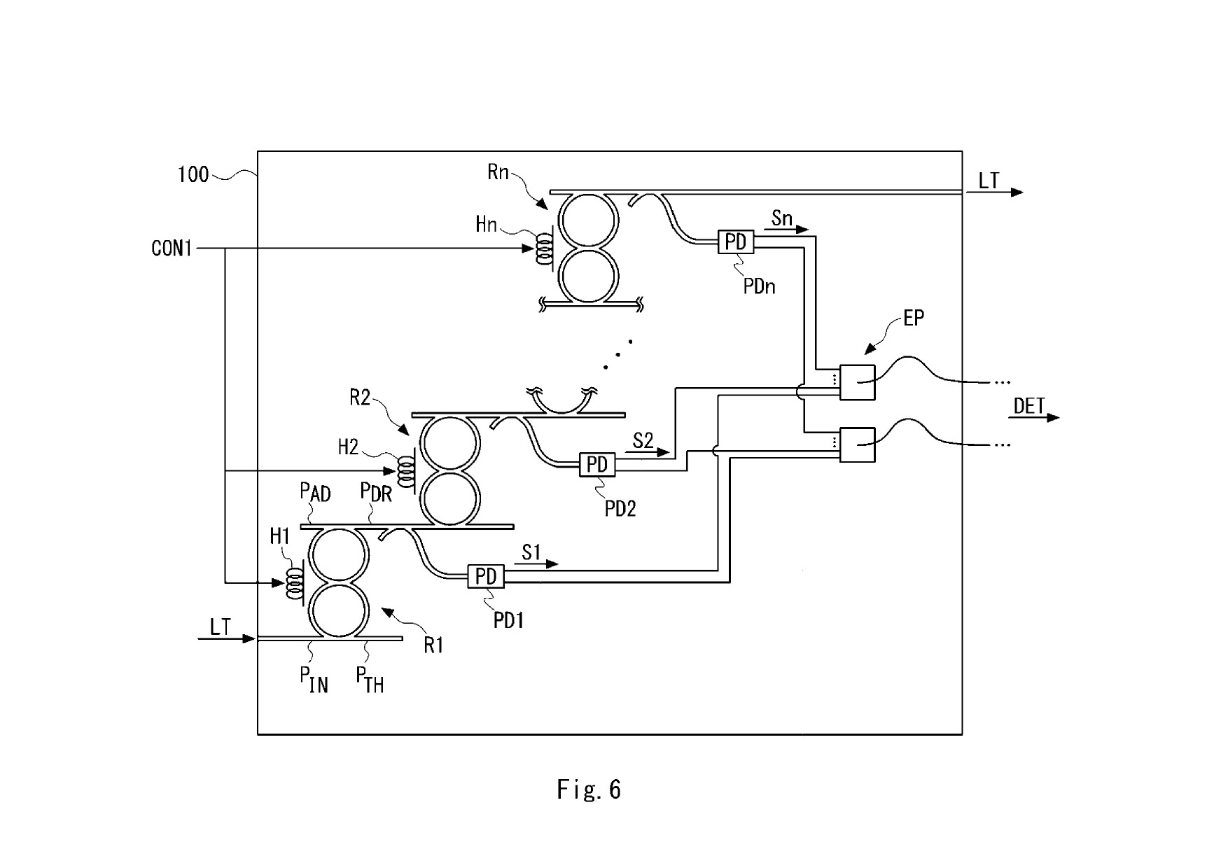

FIG. 6 is a diagram schematically illustrating a configuration of an optical wavelength variable filter according to one example embodiment. The optical wavelength variable filter 100 has a configuration in which the arrangement of the photodetectors PD1 to PDn and the number of electrode pairs are different from those of the optical wavelength variable filter 900. FIG. 6 illustrates an example in which the optical wavelength variable filter 100 includes the ring resonators R1 to Rn, the photodetectors PD1 to PDn, and the electrode pair EP.

In FIG. 6, an input port P_{IN}, a through port P_{TH}, an add port P_{AD}, and a drop port P_{DR} are displayed as representatives in the ring resonator R1 in order to indicate the ports of the ring resonator. The arrangement of the ports is similar in the ring resonators R2 to Rn.

In the optical wavelength variable filter 100, the ring resonators R1 to Rn are arranged similarly to the case of the optical wavelength variable filter 900. Therefore, the ring resonators R1 to Rn are cascaded between the input terminal of the optical signal LT and the output terminal of the optical signal LT. Focusing on two adjacent ring resonators in the ring resonators R1 to Rn, the drop port of the ring resonator at the front stage is connected to the input port of the ring resonator at the back stage. The optical signal LT is input to the input port of the ring resonator R1 at the foremost stage. The optical signal LT after wavelength filtering is output from the drop port of the ring resonator Rn at the last stage.

In order to monitor the optical signal LT transmitted through each of the ring resonators R1 to Rn, the photodetectors PD1 to PDn are connected to the drop ports P_{DR} of the ring resonators R1 to Rn by way of branch paths. As a result, some of the optical signals LT output from the drop ports P_{DR} of the ring resonators R1 to Rn are branched and input to each of the photodetectors PD1 to PDn. The photodetectors PD1 to PDn output detection signals S1 to Sn indicating the light intensity of the input optical signal LT. The photodetectors PD1 to PDn are configured as photodiodes that output current signals associated with the intensity of received light as the detection signals S1 to Sn. The anode of each of the photodetectors PD1 to PDn is connected to one of the two electrode pads included in the electrode pair EP, and the cathode is connected to the other of the two electrode pads. Hereinafter, the anode of each of the photodetectors PD1 to PDn is also referred to as one main terminal of the two main terminals, and the cathode is also referred to as the other output terminal.

As a result, for example, the control unit 1010 can receive the detection signal DET added with the detection signals S1 to Sn via the electrode pair EP. Here, the detection signal DET corresponds to the above-described output signal OUT1. In addition, one of the two electrode pads of the electrode pair EP is also referred to as a first electrode pad, and the other is also referred to as a second electrode pad. The control unit 1010 controls the micro-heaters H1 to Hn provided in each of the ring resonators R1 to Rn to maximize the intensity of the detection signal DET while sequentially sweeping the transmission bands of the ring resonators R1 to Rn, thereby setting the transmission bands of the ring resonators R1 to Rn to desired bands.

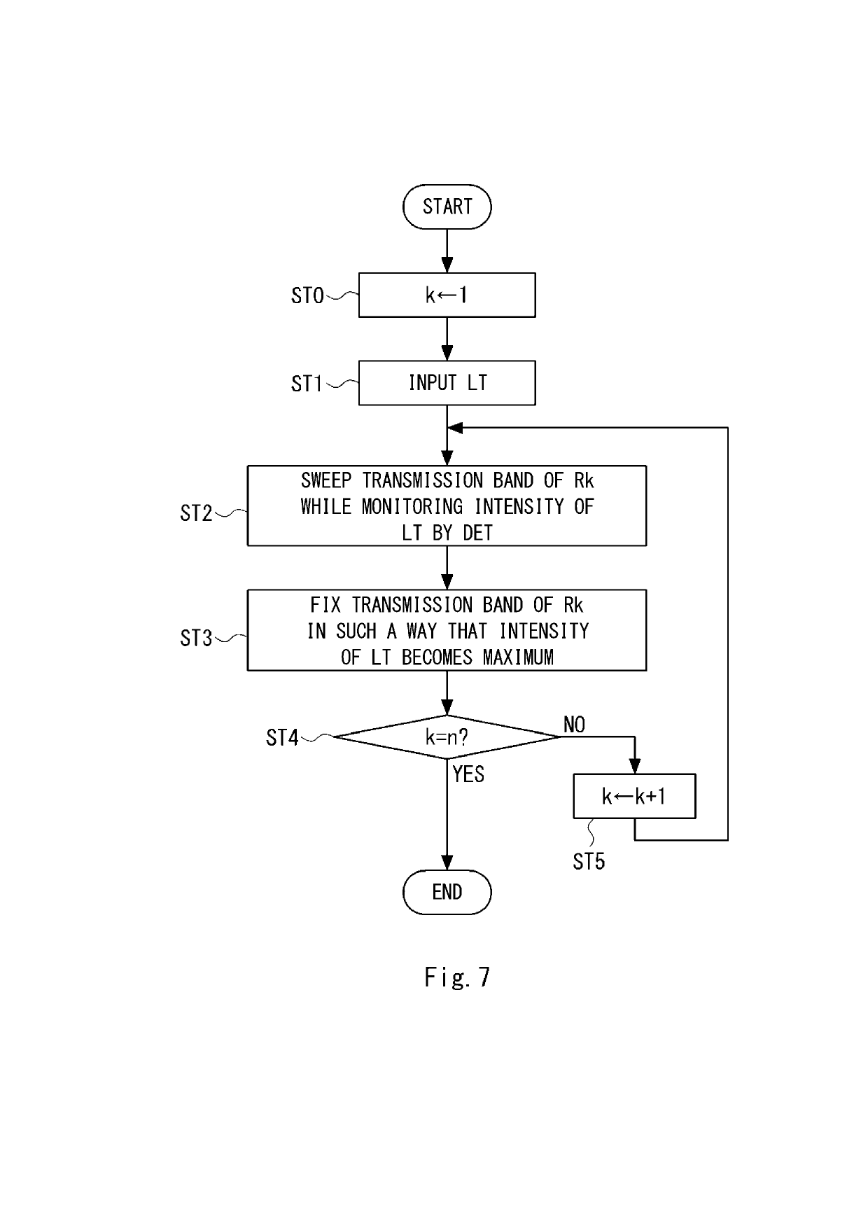

Transmission band control of the ring resonators R1 to Rn in the optical wavelength variable filter 100 will be described below. FIG. 7 is a flowchart of a transmission band control operation of the ring resonator included in the optical wavelength variable filter according to one example embodiment.

### Step ST0

The control unit 1010 sets a number k indicating a ring resonator to be subjected to a transmission band control to “1” that is an initial value.

### Step ST1

The control unit 1010 inputs the optical signal LT to the optical wavelength variable filter 100 by controlling the wavelength-variable light source 101. For example, the control unit 1010 may control the wavelength-variable light source 101 by a control signal CON1.

### Step ST2

The control unit 1010 monitors the detection signal DET through the electrode pair EP while sweeping the transmission band of the ring resonator Rk by controlling the micro-heaters H1 to Hn by the control signal CON1.

### Step ST3

The control unit 1010 fixes the transmission band of the ring resonator Rk to the transmission band at which the intensity of the detection signal DET becomes a maximum.

### Step ST4

The control unit 1010 determines whether k has reached n. In a case where k has reached n, the control unit 1010 ends the processing.

### Step ST5

In a case where k has not reached n, the control unit 1010 adds “1” to k. Thereafter, the control unit 1010 returns the processing to step ST2.

As described above, the transmission bands of all the ring resonators R1 to Rn can be suitably set at the end of the processing by sequentially adjusting the transmission bands one by one from the ring resonator on the upstream side.

In this configuration, the detection signals S1 to Sn from the photodetectors PD1 to PDn are added and input to the electrode pair EP. Therefore, the intensity of the detection signal DET increases as the ring resonators on the upstream side whose setting of the transmission band has been completed increase. On the other hand, since the transmission band of the ring resonator is adjusted one by one, the intensity of the detection signal DET at the time of adjustment varies according to the transmission band sweep of only the ring resonator to be adjusted.

Therefore, according to the present configuration, the transmission bands of the ring resonators R1 to Rn can be suitably set from the foremost stage to the last stage. The transmission band of the optical wavelength variable filter 100 can be suitably set by setting all the transmission bands of the ring resonators R1 to Rn.

Furthermore, according to the optical wavelength variable filter 100, a configuration in which only one electrode pair is provided can be adopted as compared with the general optical wavelength variable filter 900. As a result, according to the optical wavelength variable filter 100, it is possible to reduce the number of electrode pairs and reduce the dimensions of the optical wavelength variable filter as compared with the general optical wavelength variable filter 900.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the above-described example embodiment, it has been described that the transmission band of the optical wavelength variable filter is controlled by the control unit provided in the optical transceiver, but this is merely an example. For example, the transmission band of the optical wavelength variable filter may be controlled by a control unit provided in the optical transmitter or any control means provided outside the optical transceiver such as a host device of the optical transceiver.

In the above-described example embodiment, an example in which the ring resonator is used for the single filter forming the optical wavelength variable filter has been described, but this is merely an example. For example, the single filter forming the optical wavelength variable filter may be MZI. In this case, the photodetector may be connected to one of the cross port and the bar port with respect to the input port of the MZI, and the other may be an open terminal.

The optical wavelength variable filter according to the above-described example embodiment has been described as performing wavelength filtering on an optical signal output from the optical modulator in the optical transceiver and subjected to amplification, but the application is not limited thereto. The optical wavelength variable filter according to the above-described example embodiment may be applied to wavelength filtering of any light. For example, it may be mounted on a wavelength-variable light source included in the optical transceiver and used for wavelength control of light output from the wavelength-variable light source. In this case, the transmission band of the optical wavelength variable filter according to the above-described example embodiment may be controlled by a control unit provided in the wavelength-variable light source.

In the above-described example embodiment, for example, an example has been described in which the micro-heater is used as the transmission band control means of the single filter such as the ring resonator and the MZI forming the optical wavelength variable filter. However, this is merely an example. For example, a structure and method for controlling various transmission bands such as current injection into an optical waveguide forming a single filter such as a ring resonator and an MZI may be applied.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the above example embodiments may also be described as, but are not limited to, the following Supplementary Notes.

### Supplementary Note 1

An optical wavelength variable filter including a plurality of cascade-connected optical wavelength filters, a plurality of photodetectors that each detects light transmitted through the plurality of optical wavelength filters and outputs a current signal indicating intensity of the detected light via two output terminals, and an electrode pair including a first electrode pad connected to one of the two output terminals of each of the plurality of photodetectors and a second electrode pad connected to the other of the two output terminals.

### SUPPLEMENTARY NOTE 2

The optical wavelength variable filter according to supplementary note 1, in which light transmitted through an optical wavelength filter of a front stage among the plurality of optical wavelength filters is input to an optical wavelength filter of a back stage, and the photodetector that detects the light transmitted through the optical wavelength filter of the front stage detects the light transmitted through the optical wavelength filter of the front stage branched from between an output terminal of the optical wavelength filter of the front stage and an input terminal of the optical wavelength filter of the back stage.

### Supplementary Note 3

The optical wavelength variable filter according to supplementary note 2, in which in a state in which light is input to an optical wavelength filter of a foremost stage among the plurality of optical wavelength filters, a detection signal to which a plurality of the current signals output from the plurality of optical wavelength filters are added is monitored through the electrode pair, and a transmission band of each of the plurality of optical wavelength filters is set such that intensity of the light that passed through each of the plurality of optical wavelength filters becomes a maximum in order from the optical wavelength filter of the foremost stage to the optical wavelength filter of the last stage.

### Supplementary Note 4

The optical wavelength variable filter according to supplementary note 3, in which the transmission band of each of the plurality of optical wavelength filters is set such that the intensity of the detection signal becomes a maximum.

### Supplementary Note 5

The optical wavelength variable filter according to any one of supplementary notes 2 to 4, in which the plurality of optical wavelength filters are configured as ring resonators, the output terminal of the optical wavelength filter of the front stage is a drop port of the ring resonator forming the optical wavelength filter of the front stage, and the input terminal of the optical wavelength filter of the back stage is an input port of the ring resonator forming the optical wavelength filter of the back stage.

### Supplementary Note 6

The optical wavelength variable filter according to any one of supplementary notes 2 to 4, in which the plurality of optical wavelength filters are configured as Mach-Zehnder interferometers, the output terminal of the optical wavelength filter of the front stage is a cross port of the Mach-Zehnder interferometer forming the optical wavelength filter of the front stage, and the input terminal of the optical wavelength filter of the back stage is an input port of the Mach-Zehnder interferometer forming the optical wavelength filter of the back stage.

### Supplementary Note 7

An optical transceiver including, a wavelength-variable light source, an optical modulator for outputting an optical signal obtained by modulating light output from the wavelength-variable light source, an amplifier for amplifying the optical signal output from the optical modulator, and an optical wavelength variable filter according to supplementary note 1 or 2 for performing wavelength filtering on the optical signal amplified by the amplifier.

### Supplementary Note 8

A control method of an optical wavelength variable filter including a plurality of cascade-connected optical wavelength filters, a plurality of photodetectors that each detects light transmitted through the plurality of optical wavelength filters and outputs a current signal indicating intensity of the detected light via two output terminals, and an electrode pair including a first electrode pad connected to one of the two output terminals of each of the plurality of photodetectors and a second electrode pad connected to the other of the two output terminals, the method including inputting light to the optical wavelength filter of a foremost stage among the plurality of optical wavelength filters, monitoring, through the electrode pair, a detection signal obtained by adding a plurality of the current signals output from the plurality of optical wavelength filters, and setting transmission bands of the plurality of optical wavelength filters such that intensity of the light that passed through each of the plurality of optical wavelength filters becomes a maximum in order from the optical wavelength filter at the foremost stage to the optical wavelength filter at the last stage.

Some or all of the elements (e.g., configurations and functions) described in Supplementary Notes 2 to 6 dependent on Supplementary Note 1 may also depend on Supplementary Notes 7 and 8 by the same dependency relationship as Supplementary Notes 2 to 6.

1. An optical wavelength variable filter comprising:
a plurality of cascade-connected optical wavelength filters;
a plurality of photodetectors that each detects light transmitted through the plurality of optical wavelength filters and outputs a current signal indicating intensity of the detected light via two output terminals; and
an electrode pair including a first electrode pad connected to one of the two output terminals of each of the plurality of photodetectors and a second electrode pad connected to the other of the two output terminals.

2. The optical wavelength variable filter according to claim 1, wherein
light transmitted through an optical wavelength filter of a front stage among the plurality of optical wavelength filters is input to an optical wavelength filter of a back stage, and
the photodetector that detects the light transmitted through the optical wavelength filter of the front stage detects the light transmitted through the optical wavelength filter of the front stage branched from between an output terminal of the optical wavelength filter of the front stage and an input terminal of the optical wavelength filter of the back stage.

3. The optical wavelength variable filter according to claim 2, wherein
in a state in which light is input to an optical wavelength filter of a foremost stage among the plurality of optical wavelength filters, a detection signal to which a plurality of the current signals output from the plurality of optical wavelength filters are added is monitored through the electrode pair, and
a transmission band of each of the plurality of optical wavelength filters is set such that intensity of the light that passed through each of the plurality of optical wavelength filters becomes a maximum in order from the optical wavelength filter of the foremost stage to the optical wavelength filter of the last stage.

4. The optical wavelength variable filter according to claim 3, wherein the transmission band of each of the plurality of optical wavelength filters is set such that the intensity of the detection signal becomes a maximum.

5. The optical wavelength variable filter according to claim 2, wherein
the plurality of optical wavelength filters are configured as ring resonators,
the output terminal of the optical wavelength filter of the front stage is a drop port of the ring resonator forming the optical wavelength filter of the front stage, and
the input terminal of the optical wavelength filter of the back stage is an input port of the ring resonator forming the optical wavelength filter of the back stage.

6. The optical wavelength variable filter according to claim 2, wherein
the plurality of optical wavelength filters are configured as Mach-Zehnder interferometers,
the output terminal of the optical wavelength filter of the front stage is a cross port of the Mach-Zehnder interferometer forming the optical wavelength filter of the front stage, and
the input terminal of the optical wavelength filter of the back stage is an input port of the Mach-Zehnder interferometer forming the optical wavelength filter of the back stage.

7. An optical transceiver comprising:
a wavelength-variable light source;
an optical modulator for outputting an optical signal obtained by modulating light output from the wavelength-variable light source;
an amplifier for amplifying the optical signal output from the optical modulator; and
an optical wavelength variable filter according to claim 1 for performing wavelength filtering on the optical signal amplified by the amplifier.

8. A control method of an optical wavelength variable filter including a plurality of cascade-connected optical wavelength filters, a plurality of photodetectors that each detects light transmitted through the plurality of optical wavelength filters and outputs a current signal indicating intensity of the detected light via two output terminals, and an electrode pair including a first electrode pad connected to one of the two output terminals of each of the plurality of photodetectors and a second electrode pad connected to the other of the two output terminals, the method comprising:
inputting light to the optical wavelength filter of a foremost stage among the plurality of optical wavelength filters;
monitoring, through the electrode pair, a detection signal obtained by adding a plurality of the current signals output from the plurality of optical wavelength filters; and
setting transmission bands of the plurality of optical wavelength filters such that intensity of the light that passed through each of the plurality of optical wavelength filters becomes a maximum in order from the optical wavelength filter at the foremost stage to the optical wavelength filter at the last stage.
